(19) United States
(12) Patent Application Publication
(10) Pub. No.: US 2006/0218035 A1
(43) Pub. Date: Sep. 28, 2006

(54) Method of introducing advertisements and providing the advertisements by using access intentions of internet users and a system thereof

(76) Inventors: Sang Won Park, Kyunggido (KR); Jae Young Han, Seoul (KR); Kwon Su Na, Jeollanam-do (KR)

Correspondence Address: LADAS & PARRY LLP, 224 SOUTH MICHIGAN AVENUE, SUITE 1600, CHICAGO, IL, 60604, US

(21) Appl. No.: 10/552,956

(22) PCT Filed: Apr. 21, 2004
(86) PCT No.: PCT/KR04/00907

§ 371 Date: Oct. 14, 2005

(30) Foreign Application Priority Data
Apr. 22, 2003 (KR) 10-2003-0025400

(51) Int. Cl. G07G 1/14

(52) U.S. Cl. 705/14

(57) ABSTRACT

The present invention relates to a method and system for grasping an interested field of an Internet user, i.e., access intention of the Internet user, attracting advertisement from a plurality of sponsors on the Internet using the user's access intention, and providing the advertisement to the user on the Internet. According to a preferred embodiment of the present invention there is provided a method for generating advertisement information to attract advertisement on an Internet, the method comprising the steps of maintaining a keyword database for recording more than one keyword, type information of the keyword, predetermined reference information that corresponds to the type information, and advertisement list information that corresponds to the keyword, in which the advertisement list information includes information for the number of advertisement files including the keyword; receiving a predetermined event from a user, recording a keyword that corresponds to the received event, for history data; searching for the type information of the keyword by referring to the keyword database; searching for the reference information that corresponds to the searched type information; judging whether the keyword is an interested field of the user on the basis of the searched reference information; generating an advertisement file including the keyword regarded as the interested field of the user, updating the information for the number of advertisement files in the advertisement list information stored in the keyword database; and generating advertisement information including the keyword and the updated advertisement list information.

### TECHNICAL FIELD

The present invention relates to a method and system for grasping an interested field of an Internet user, i.e., access intention of the Internet user, attracting advertisement from a plurality of sponsors on the Internet using the user's access intention, and providing the advertisement to the user on the Internet, and more particularly to a method and system for grasping type of information desired by the Internet user by analyzing an event input from the Internet user, attracting the advertisement related to the Internet user's access intention, or providing the advertisement to the user on the Internet by judging the user's access intention through analysis of the event.

### BACKGROUND ART

For a method for analyzing an interested field of a user and providing predetermined information among conventional arts, there exist a method for receiving an interested field of a user who intends to join as a member upon member joining, and periodically, or non periodically providing information related to the interested field through an electronic mail, to the user who has joined as a member, or a method for providing the advertisement related to the received interested field, to the user in case the user logs in.

If a user makes an entry on an interested list, the interested list is classified and stored for each user, and the user is judged to be interested in the field described on the interested list as far as the user does not modify the interested list through a separate procedure. According to such conventional art, there is a problem of not being able to provide information in which a user's interest changing variously according to time flow is actively reflected. Also, there is a problem of not being able to grasp temporary interest information, not continuous interest information. For example, in case an Internet user moves next month, an interest for moving increases for a predetermined period of time, and after the Internet user moves, the interest for moving decreases. But, according to the conventional art, there is a problem of not being able to grasp such temporary interest information. And, in case a user himself records an interested field of himself, as the interested field is roughly categorized, there has been a difficulty in understanding an interest field of a user more accurately.

FIG. 1A is a view showing an example of an advertising method by displaying advertisement related to a keyword on a part of a screen in case of searching for a web page using a keyword according to the conventional art.

The advertising method shown in FIG. 1A operates in the following way, in which: if a user inputs a predetermined keyword “forming” 110, the user is estimated to have an interest in a plastic operation or plastic surgery which are related to the keyword “forming” 110, and an advertisement 120 of a plastic surgery is displayed on a part of the screen. Above advertising method can obtain an effect of increasing advertisement effect by providing advertisements related to information desired to be searched on a web page by a user. But such advertising method provides the relevant advertisement only at the time the user inputs the relevant keyword, therefore, there are problems that advertisement impression is not consistent and the number of advertisements that can be displayed on the screen with respect to the relevant keyword is limited. For example, a user who frequently inputs the keyword “forming” is much interested in “forming”, therefore, if an advertisement for “forming” is displayed even when the user inputs other keyword, the number of advertisement impressions increases and also click rate of the advertisement will increase, so that the advertisement effect will increase even more. Also, if not only the advertisement but also useful information related to “forming” is provided to the user, satisfaction of the user will much increase.

FIG. 1B shows an example of an advertisement attracting screen for providing a predetermined advertisement related to a predetermined keyword shown in FIG. 1A, to a user. Referring to FIG. 1B, there are four kinds of advertisements that can be provided to the Internet user. As shown in FIG. 1A, the classification for providing an advertisement related to a predetermined keyword, i.e., a general keyword advertisement is the part “1.banner advertisement”, “2.question guide advertisement”, “3.sponsor link” represented by the reference numeral 151. Also, in case the Internet user searches for information that belongs to a specific category, it may be possible to provide an advertisement related to the relevant category. Such advertising method is the part represented by the reference numeral 152.

As described above, as the advertisements through the Internet is widely used, a plurality of sponsors intends to provide their advertisements on the Internet with respect to a specific keyword, but there are problems that the number of advertisements that can be provided on one user interface screen is limited with respect to one keyword and the keyword capable of providing the advertisement may be exhausted. Therefore, a matter that an Internet advertising enterprise should search for a new advertisement scope and make benefit out of it, is now emerging as a desperate issue.

### DISCLOSURE OF INVENTION

It is, therefore, an object of a method and system for attracting and providing advertisements on the Internet using an Internet user's access intention according to the present invention, to maximize an advertisement effect, by grasping an Internet user's access intention and by getting a sponsor intending to advertise a predetermined advertisement on the Internet, to possibly provide an advertisement to a user who is interested in a field related to the advertisement of the sponsor.

It is another object of a method and system for attracting and providing advertisements on the Internet using an Internet user's access intention according to the present invention, to resolve the problem of exhaustion of the advertisement resources, by providing a new advertisement scope, growing out of the advertising method based on the general keyword advertisement of the conventional art.

It is still another object of a method and system for attracting and providing advertisements on the Internet using an Internet user's access intention according to the present invention, to create a new advertisement method by grasping an Internet user's access intention in advance and by providing the Internet user's access intention to a sponsor, who wants to provide an advertisement related to such access intention, to a user through the Internet.

To achieve the foregoing objects, according to a preferred embodiment of the present invention there is provided a method for generating advertisement information to attract advertisement on an Internet, the method comprising the steps of maintaining a keyword database for recording more than one keyword, type information of the keyword, predetermined reference information that corresponds to the type information, and advertisement list information that corresponds to the keyword, in which the advertisement list information includes information for the number of advertisement files including the keyword; receiving a predetermined event from a user; recording a keyword that corresponds to the received event, for history data; searching for the type information of the keyword by referring to the keyword database; searching for the reference information that corresponds to the searched type information; judging whether the keyword is an interested field of the user on the basis of the searched reference information; generating an advertisement file including the keyword regarded as the interested field of the user; updating the information for the number of advertisement files in the advertisement list information stored in the keyword database; and generating advertisement information including the keyword and the updated advertisement list information.

According to another aspect of the present invention, there is provided a method for attracting an advertisement on an Internet, the method comprising the steps of maintaining a keyword database for storing more than one keyword and advertisement information generated according to the method as described in claim 1 in response to the keyword; receiving an advertisement request that includes an advertisement keyword from a first sponsor; searching for advertisement information that corresponds to the advertisement keyword by referring to the keyword database; processing the searched advertisement information and providing guiding information data to a web browser of the first sponsor; receiving a confirmation response from the first sponsor, in which the confirmation response includes first advertisement data of the first sponsor; and recording, in a first advertisement database, the advertisement keyword and the first advertisement data that corresponds to the advertisement keyword.

According to another aspect of the present invention, there is provided a method for providing a predetermined advertisement to a user of a search engine, the method comprising the steps of maintaining an advertisement database for storing more than one keyword and more than one advertisement data that corresponds to the keyword; receiving an access request from a user, in which the access request includes an advertisement file stored in a user's terminal; extracting a keyword recorded in the received advertisement file; searching for the advertisement data that corresponds to the keyword by referring to the advertisement database; and processing the searched advertisement data and providing the same to a web browser of the user; wherein the advertisement database is updated through the steps of maintaining a keyword database for storing more than one keyword and advertisement information generated according to the method as described in claim 1 in response to the keyword; receiving an advertisement request that includes an advertisement keyword from a sponsor; searching for advertisement information that corresponds to the advertisement keyword by referring to the keyword database; processing the searched advertisement information and providing guiding information data to a web browser of the sponsor; receiving a confirmation response from the sponsor, in which the confirmation response includes advertisement data of the sponsor; and recording, in an advertisement database, the advertisement keyword and the advertisement data that corresponds to the advertisement keyword.

Also, according to another aspect of the present invention, there is provided an Internet advertisement system comprising a central server having: a keyword database for recording more than one keyword, type information of the keyword, predetermined reference information that corresponds to the type information, advertisement list information that corresponds to the keyword, in which the advertisement list information includes information for the number of the advertisement files that include the keyword; a communication part for receiving a predetermined event from a user; a processing part for recording a keyword that corresponds to the received event, for history data, searching for the type information of the keyword and the reference information that corresponds to the searched type information by referring to the keyword database, and judging whether the keyword is the interested field of the user according to the searched reference information; an advertisement file preparing part for extracting the keyword judged to be the interested field of the user, and generating an advertisement file that includes the extracted keyword, in which the advertisement file includes more than one among a user's terminal number (PC ID), an identifying symbol of the user, and expiration date information of the advertisement file; an advertisement information generating part for updating information for the number of advertisement files in the advertisement list information stored in the keyword database, and generating advertisement information including the keyword and the updated advertisement list information; and an advertisement server having: an advertisement database for storing more than one keyword and more than one advertisement data that corresponds to the keyword; an advertisement transmitting part for processing advertisement data that corresponds to the keyword included in the advertisement file by referring to the advertisement database, and providing the processed advertisement data to a web browser of the user; a storing part for storing history information about providing of the advertisement data; an analyzing part for providing predetermined feedback information to a sponsor who has registered the advertisement data, on the basis of the stored history information.

### BRIEF DESCRIPTION OF DRAWINGS

FIG. 1A is a view showing an example of an advertising method by displaying advertisement related to a keyword on a part of a screen in case of searching for a web page using a keyword according to the conventional art.

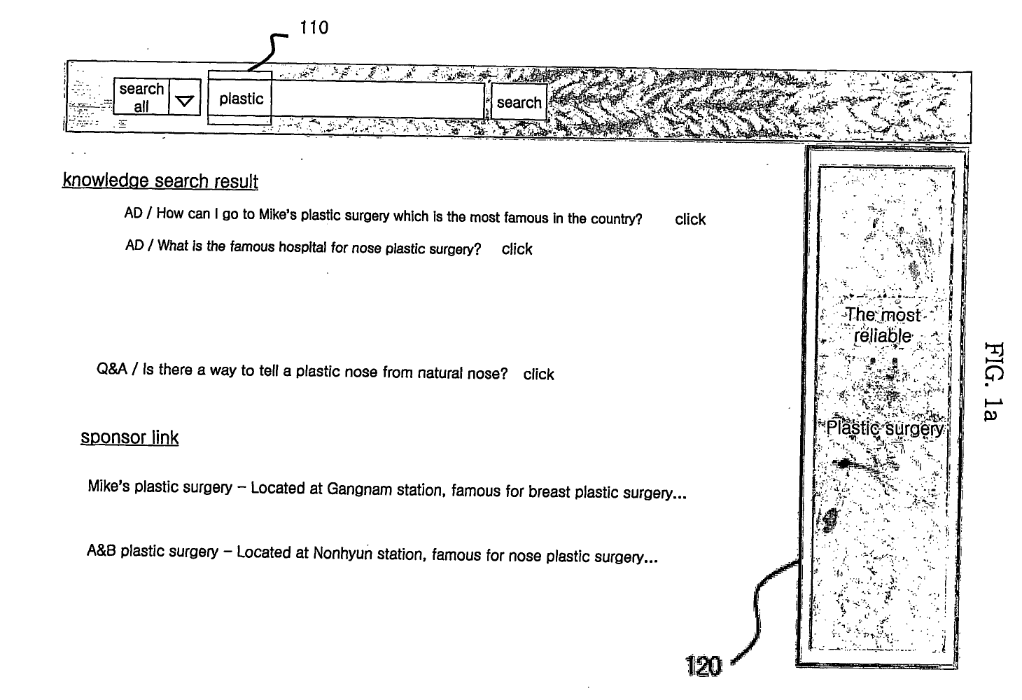

FIG. 1B is a view shows an example of the method for attracting the advertisement on the Internet according to the conventional art.

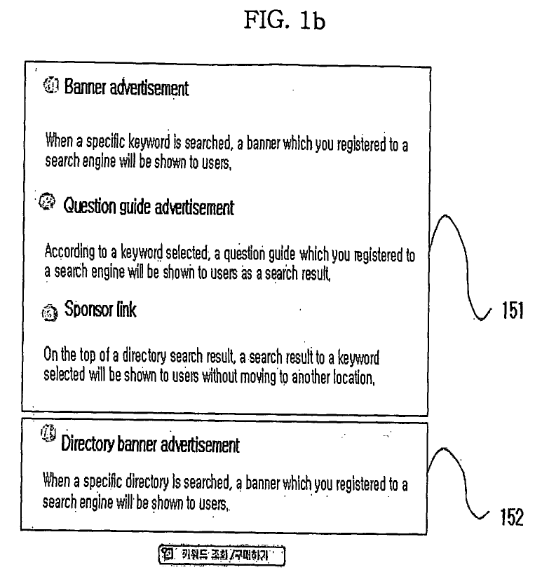

FIG. 2 is a flowchart showing the method for judging the Internet user's access intention according to one embodiment of the present invention.

FIG. 3 is a flowchart showing a flow of a method for generating a list of user's access intention keyword data for use in the method for attracting and providing the advertisement using the Internet user's access intention of the present invention.

FIG. 4 is a structural block diagram showing an example of the system in which the method for generating the list of the user's access intention keyword data of the present invention shown in FIG. 3, is performed.

FIG. 5 is a structural block diagram showing another example of the system in which the method for generating the list of the user's access intention keyword data of the present invention shown in FIG. 3, is performed.

FIG. 6 is a flowchart showing a flow of the method for generating the list of the user's access intention keyword data according to another embodiment of the present invention.

FIG. 7 is a view showing an example of the method for attracting the advertisement on the Internet using the Internet user's access intention.

FIG. 8 is a flowchart showing the method for attracting the advertisement on the Internet according to the embodiment of the present invention.

FIG. 9 is a flowchart showing an example of the method for providing the advertisement on the Internet according to the present invention.

FIG. 10 is a structural block diagram showing an example of the system for attracting and providing the advertisement on the Internet using the Internet user's access intention according to the present invention.

FIG. 11 is an inner block diagram of the general computer system that can be used for the method and system for attracting and providing advertisement on the Internet using the Internet user's access intention of the present invention.

### BEST MODE FOR CARRYING OUT THE INVENTION

A preferred embodiment of a method for judging an Internet user's access intention and a method and system for advertising on the Internet using such access intention according to the present invention, will be described in detail with reference to the accompanying drawings.

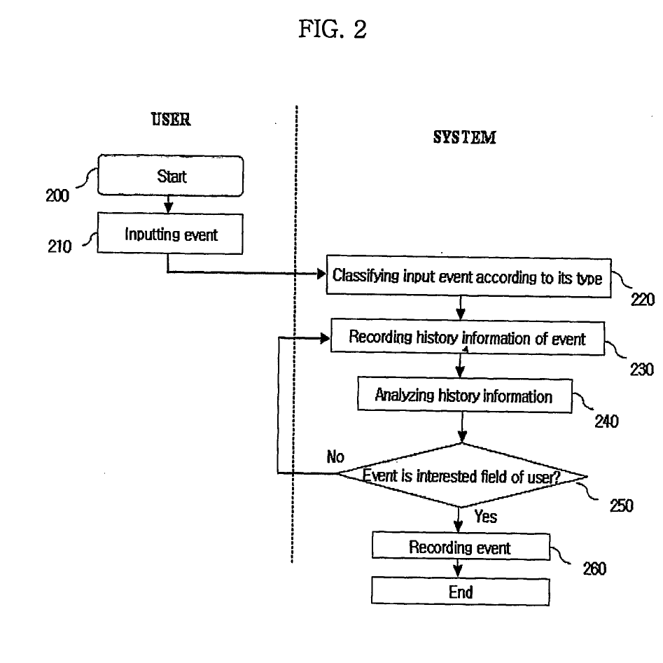

FIG. 2 is a flowchart showing the method for judging the Internet user's access intention according to one embodiment of the present invention.

The Internet user accesses to the Internet for a variety of reasons. Information searching through the Internet is one of the primary reasons of the Internet access, and generally, a user accesses to the Internet for the reasons such as a game, use of an electronic mail, financial transaction. The method for judging the Internet user's access intention according to one aspect of the present invention can understand a user's access intention even in case of all embodiments such as chatting and messenger service where data that may be a basis for understanding a user's intention, is input from a user, as well as understand a user's access intention mainly in case of accessing to the Internet for the purpose of information searching through the Internet, whose ratio is investigated to be highest, among a variety of access intention of an Internet user.

Referring to FIG. 2, the method for judging the Internet user's access intention according to an embodiment of the present invention will be described in the following. To judge the Internet user's access intention, a predetermined event is input from the user on the first place (the step of 210). Methods for receiving a predetermined event may be classified into three groups as follows.

(1) An Internet user accesses to a portal site that provides a search engine to input a keyword required for a predetermined information searching. In that case, an event is an input of a keyword by a user. Also, as described above, the keyword may be determined mainly from a frequently referred word while a user does chatting or uses messenger service as well as uses the search engine. For example, if words such as “shoes”, or “shopping” is frequently referred upon using of the messenger service, such word is collected and it can be determined that the event input from a user is about “shoes” or “shopping”.

(2) An Internet user executes a web browser to input an URL (Universal Resource Locator) of a website where predetermined information is located, at an address input window of the web browser. At the moment, an event is an input of an URL by the Internet user. In that case, the event can be specified in the following way, in which: only foremost part among the above URL is extracted, and then which type the extracted foremost URL belongs to, is judged. For example, if a user inputs an address of “http://www.kipo.go.kr/patentlaw.htm” at the address input window, the part “www.kipo.go.kr”, which is the foremost part of the above URL, is extracted, so that the extracted URL is judged to be the URL that belongs to patent or trademark, whereby it is possible to specify that the event input by a user is about patent or trademark. If the event input by a user is an IP (Internet Protocol) address, it may be possible to obtain a domain name for the IP address by performing reverse domain name service query.

(3) An Internet user clicks on a hypertext linked to predetermined information displayed on a website. In that case, an event input from a user may be specified by extracting content information of the hypertext. For example, if a user clicks on a word “patent” represented as a hyperlink to move to information related to “patent”, it is possible to specify that the event input from a user is about “patent”.

After the event of the Internet user is received as described above, the event is classified according to its type (the step of 220). The type at the step of 220 means a set of a predetermined pattern of the event input by a user. For example, in case a user inputs a keyword “patent”, it is possible to classify the event according to its type, depending on what kind of character the event of the keyword “patent” has. Such type classification is performed to judge that the event input from a user is really an event that can be considered to be an interested field of a user. In case a user arbitrarily inputs a keyword “patent” one time, it is unreasonable to judge that “patent” is an interested field of a user on the basis of such one time searching, but in case a user inputs a keyword “flower delivery” one time, it is reasonable to judge that the user is presently interested in “flower delivery” in view of characteristics of the keyword. As described above, the step of 220 is a step of judging as to which type the received event belongs to, and classifying the same.

After the event input from the user is classified according to its type, history information of the event is recorded (step of 230). The history information may include information about the number of times the event is input, between how long period of time the event is input. According to a preferred embodiment of the present invention, the history information may be recorded in form of a cookie file, and the cookie file where the history information is recorded may be stored in a user's terminal or a system for understanding a user's access intention of the present invention. Next, the recorded history information of the event is analyzed (the step of 240), and an interested field of a user is judged according to a predetermined reference on the basis of the analyzed information (the step of 250). The step of judging the interested field of the user by analyzing the history information of the event (the steps of 240 and 250) may be performed according to a predetermined reference on the basis of a type of the event input from the user as described above. On the first place, the step of 240 analyzes the number of times the event is input, and the period (the period between the first input and the second input) during which the event is input, which is recorded in the history information. On the basis of the analysis results, whether the event expresses an interested field of a user is judged according to a predetermined reference (the step of 250). The predetermined reference is several conditions selected for each type of the events input by a user, and may include more than one among the number of times the event is input, i.e., frequency of the event generation, recentness of the event generation, and priority set in advance in connection with the event.

A variety of predetermined references for judging a user's access intention according to the type to which the event belongs, may be provided. Namely, if the event input from a user, e.g., the keyword input by a user is “flower delivery”, it is estimated that immediacy of considerable degree is required in view of the characteristics of the keyword “flower delivery”. Namely, as a user may have intention to deliver a flower soon, it may be judged that the interest of the user and immediacy are strong in case of such keyword having strong immediacy. Regarding such kind of event, even in case the number of times the event is input from a user is only one time, it is possibly judged that the user is highly interested and, therefore, the event directly expresses the user's access intention as it is. On the contrary, if the event input by the user, i.e., the keyword input by the user is “emigration” or “study abroad”, the immediacy is possibly judged to be very low compared to the case of “flower delivery” in view of the characteristics of the keywords “emigration” or “study abroad”. Namely, it is possible to judge that the user has an intention to consistently pay an interest for the keyword for a considerable period of time, therefore, it is unreasonable to judge that the user's access intention is expressed as it is merely with the keyword. But, in case the keyword is input more than five times for one month, it is possible to judge that a user has a considerable interest or a consistent interest for the field of “study abroad” and also the user's access intention is for searching information about the above field. For such judgment, the above described predetermined references are applied, and such references include the fact of how recently such reference is input or the fact of what priority the event has. For example, in case the event input yesterday is input again today, it is possible to judge that the interest of the user is greater than a request input before one week, and it is possible to set in such a way that the event related to “flower delivery” or “restaurant” may have more higher priority than the event related to “emigration” or “study abroad”. The above-described predetermined reference set for each keyword may be recorded, for each relevant keyword, in a keyword database of the system for providing advertisement of the present invention.

The step of 250 judges whether the event input at the step of 210 expresses the interested field of the user on the basis of the above-described predetermined reference. If the event is judged to meet the above-described predetermined reference, the event is recorded (step of 260) and if the event is judged not to meet the above-described predetermined reference, the procedure returns again back to the step of 230.

The event judged to express the interested field of the user at the step of 250, is recorded as the interested field of the user (the step of 260). According to a preferred embodiment of the present invention, the event judged to express the interested field of the user may be recorded in form of a cookie file. It is also possible to record the interested field of the user in form of a cookie file and store the same in a user's side, or store the same in the system for understanding the user's access intention of the present invention. Also, for another embodiment of the method for recording the interested field of the user, there is a method for classifying the judged and interested field of the user and storing the same for each user. It is possible to manage the interested field for each user using a predetermined database means prepared in a side of a central server for understanding the user's access intention, and it is possible that the central server only understands the user's access intention and a separate server means for storing the above-understood user's access intention is prepared so that predetermined information including advertisement is provided to each user using such access intention.

The event judged to express the above-recorded interested field of the user can be updated consistently in case there is another input of the event from the user and the event is judged to express the interested field of the user according to the described predetermined reference as a result of analysis of the recorded history information after such event is classified according to its type. According to an embodiment of the present invention, there may be a plurality of events recorded as the interested field of the user at the step of 260.

The method for judging the user's access intention according to the present invention may be designed to judge the interested field of the user according to an arbitrary request input from a user, but for accuracy of such judgment, it is possible to restrict the number of requests or range by which the interested field can be judged. In that case, it is possible to judge more accurately the interested field of the user, i.e., the user's access intention, therefore, it is possible to use more effectively the judged user's access intention. For example, it is also possible to determine the event that is judged to most highly reflect the user's intention among the events, and to perform the above-described judgment of the interested field if and only if the event input from the user is included in the above-determined event. In that case, since the steps of classifying for each type and recording the history information need not to be performed with respect to the events judged not to properly reflect the user's intention, there are strong points that storing space is effectively used and the system is easily realized.

According to a preferred embodiment of the present invention, the described method for judging the user's access intention can be performed by installing a predetermined client program in a user's side. Namely, the client program installed in the user's terminal may operate to monitor the user's event (input of a keyword or a predetermined URL, or click of the hyperlink), classify the event according to its type, record the history information of the event, analyze the recorded history information, and judge the interested field of the user according to the described predetermined reference. According to the present embodiment, there is a strong point of understanding the interested field by monitoring all cases where a user makes use of a plurality of Internet services. For example, not only when a user inputs a keyword at the search site named “A” but also when a user inputs a keyword at the search site named “B”, the keywords can be all traced as an event, therefore, it is possible to understand more accurately the interested field of the user.

Also, according to an embodiment of the present invention, it is possible to get a user to input basic information such as sex, age, address, occupation of a user before installation of the client program, so that those information can be referred in judging the interested field of the user. For example, if the user is a married woman in her age of thirties, the interested field of the user can be judged with priority given on baby sitting, cooking. Also, according to an embodiment of the present invention, in case a sample where a predetermined objectivity can be guaranteed, is secured, it is possible to consistently judge the present interested field of the Internet user according to their ages and sexes, and to use the judged interested field of the Internet user in a variety of ways.

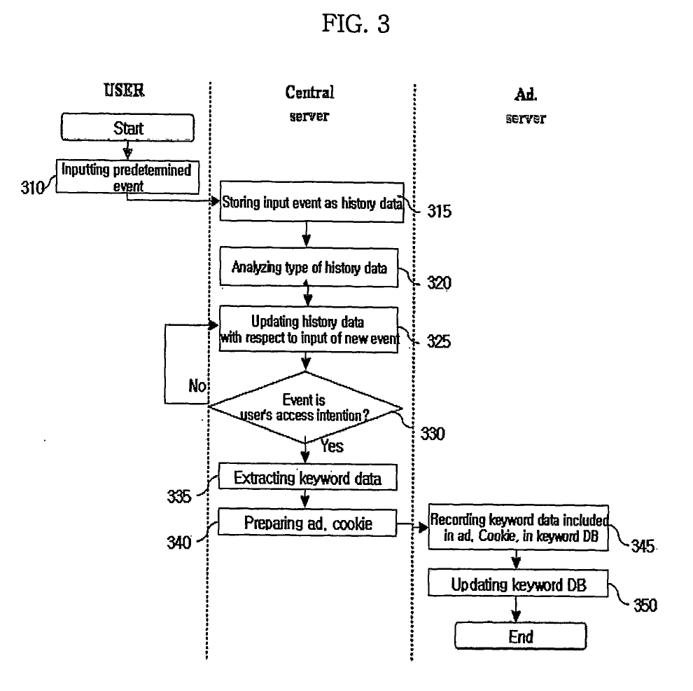

FIG. 3 is a flowchart showing a flow of a method for generating a list of user's access intention keyword data for use in the method for attracting and providing the advertisement using the Internet user's access intention of the present invention. Referring to FIG. 3, the method for generating the list of the keyword data on the Internet of the present invention is performed in the following way, using the described method for judging the Internet user's access intention.

In the embodiment of the method shown in FIG. 3, history data for recording an event log of a user and an advertisement file for recording the event regarded as the user's access intention through analysis of the event, are used. Though, for convenience in explanation, an advertisement cookie file is used as an example of the advertisement file in the present embodiment, it would be obvious to a person of an ordinary skill in the art that any file whatsoever can be used as far as a file can record history of a predetermined event or an analyzed event.

Referring to FIG. 3, just like the method for judging the Internet user's access intention shown in FIG. 2, a predetermined event is input from a user (the step of 310) and the received event is stored as history data (the step of 315). According to a preferred embodiment of the present invention, the history data may be a cookie file.

As is well known to a person of an ordinary skill in the art, a cookie is a special text file which a website can leave at a user's system. Such cookie is designed to get a predetermined system to memorize something with respect to the user afterward. In case of using HTTP (Hyper Text Transfer Protocol), each request for a web page is all independent regardless of other requests. Therefore, a web server dose not have any record as to which page has been transmitted to the user previously, and further, it is also difficult that a web server knows which website the user has visited previously. The cookie is a device for allowing the web server to store a file regarding the web access by the user, in the user's computer. Generally, the cookie file is stored in a lower part of a directory of the browser used by the user.

The cookie is set to document.cookie in its attribute with the following form:

name=value;expire=expDate

name: it is stored in a virtual space of the browser and it is a name of a cookie for discriminating cookies each other

value: cookie value

expire: termination time limit during which a cookie as a keyword possibly exists in a cookie file

expDate: termination time limit of a cookie consisting of GMT (Greenwich Mean Time) format

The cookie is a file stored in the computer of a user. In Netscape, it is possible to store this file of up to 300 at the maximum, at a single system, and a size of one file is limited to less than 4 KB. According to a preferred embodiment of the present invention, the cookie file may include a predetermined user PC number, more than one keyword that is judged to be the interested field of the user, a termination time limit of the cookie file, etc.

Next, the type of the received event is analyzed (the step of 320). The type means a predetermined type as to what kind of attribute the event has. Such type can be classified according to a degree of immediacy which the event has, i.e., a period (“effective period” hereinafter) during which the event is understood to be effective in understanding the interested field of the user. More specifically, in case the received event is an event such as “flower delivery” that strongly requires immediacy, that event is classified as a type whose effective period is one day (day reference), and in case the received event is an event such as “computer” for which intention transition needs to be considered for a predetermined period of time, that event is classified as a type whose effective period is one week (week reference), and in case the received event is an event such as “study abroad” for which relatively long period transition needs to be considered, that event is classified as a type whose effective period is one month (month reference).

The event history data is updated whenever a new event is input (the step of 325). According to an embodiment of the present invention, the number of events stored in the event history data may be limited to a predetermined number of advertisement files, and the above updating can be performed in a manner of FIFO (First In First Out). The FIFO is for maintaining recentness of the event and effectively using the storage space, by most firstly eliminating the most firstly received event, from the event history data.

Also, the event stored in the event history data may be limited to a predetermined event, which is designed to prevent an event input by the user without any intention from being stored in the event history data. Such limitation in the event not only can get the interested field of the user to be more accurately judged but also can reduce system load required in judging the interested field of the user.

Also, according to the embodiment of the present invention, it is possible to set expiration period with respect to the predetermined event, and to eliminate the event from the event history data if the event is the predetermined event and the period during which the event is stored passes the expiration period. For example, suppose that the event is an input of a keyword “flower delivery” and the expiration period for the event is set to one day (the keyword “flower delivery” has strong immediacy as described above). In that case, if one day elapses with the keyword “flower delivery” stored in the event history data, the keyword “flower delivery” may be deleted from the event history data regardless of the described method of FIFO.

Next, on the basis of the type analyzed at the step of 320, whether the event included in the history data is the user's access intention, is judged according to a predetermined reference (the step of 330). As described above, the predetermined reference is several conditions selected for each event of the user, which may include more than one among the number of times the event is input, i.e., frequency of the event generation, recentness of the event, and priority set in advance in connection with the event. For example, in case the number of times the keyword “flower delivery” is input, that is an event whose effective period is classified to be one day, is more than two times a day, or in case the number of times the keyword “computer” is input, that is an event whose effective period is classified to be one week, is more than three times a week, or in case the number of times the keyword “study abroad” is input, that is an event whose effective period is classified to be one month, is more than five times a month, the event is judged to be the interested field of the user and may be stored in the advertisement cookie. As described above, a specific keyword, a type of the keyword, a predetermined reference for the keyword may be recorded for each keyword in the keyword database of the system of the present invention.

Also, the priority may be determined according to the number of clicks of the advertisements related to the event for a predetermined period of time. For example, in case a user clicks an advertisement related to the keyword “baldhead” as an event more than five times for thee days, the user is possibly judged to have great interest in the field related to “baldhead”, therefore, it is possible to set such event to have high priority compared to other events.

The event judged to be the user's access intention is extracted as keyword data from the history data (the step of 335). The advertisement cookie is prepared on the basis of the extracted keyword data (the step of 340).

According to the embodiment of the present invention, the advertisement may include the event judged to be the interested field of the user and a predetermined advertisement identifying symbol (ID) for expressing an advertisement related to the event or the position where the advertisement is stored. A predetermined keyword data included in the prepared advertisement cookie is recorded in a predetermined keyword database as a sale-object keyword which is used in the method for attracting and providing advertisement using the Internet user's access intention of the present invention (the step of 345), and in the keyword database, data recorded on a field for the number of issues of an advertisement cookie or a filed for a user PC number for which an advertisement cookie is issued, is consistently updated according to predetermined keyword data whenever the advertisement cookie in which the predetermined keyword data is included, is issued (the step of 350).

According to another embodiment of the present invention, the advertisement cookie is stored in the side of the user, but according to still another embodiment of the present invention, in case processing capacity of the central server or a predetermined advertisement server operating in cooperation with the central server is large enough, it is possible that the central server or the advertisement server stores and manages, for each user, the event and the advertisement identifying symbol related to the interested field of the user.

According to a preferred embodiment of the present invention, the present invention may be constructed in such a way that the advertisement cookie is effective for a predetermined period of time and is automatically deleted due to period expiration if a predetermined period of time elapses. As mentioned in description of the cookie file, it is possible to control the cookie to be effective only for a predetermined period of time by adjusting expDate in the inside of the cookie file.

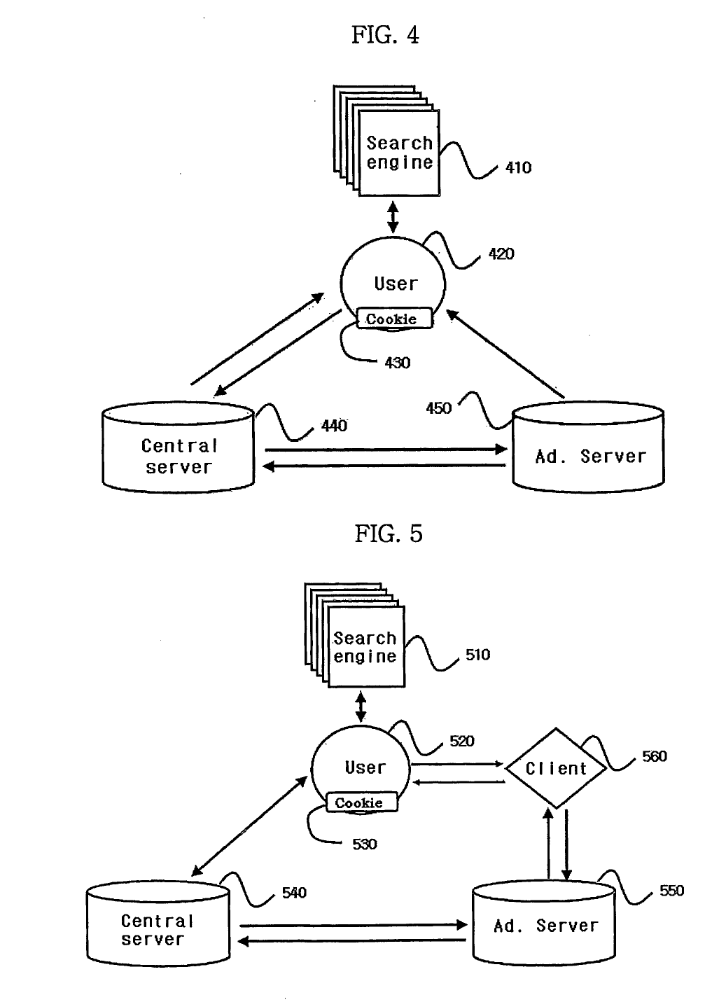

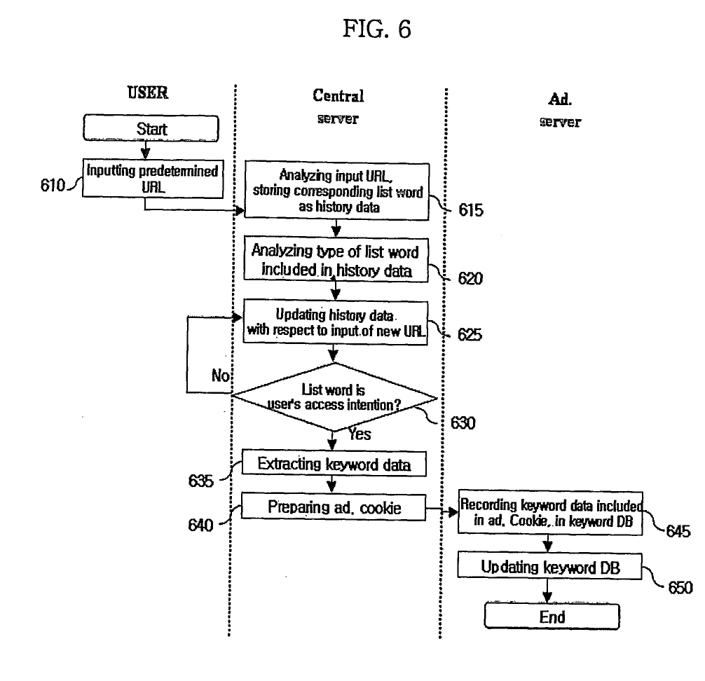

FIGS. 4 and 5 are structural block diagrams showing an example of a system where the method for generating the list of the user's access intention keyword data of the present invention is performed. The system shown in FIGS. 4 and 5 where the method for generating the list of the user's access intention keyword data of the present invention is performed, is an embodiment for the case of using, as the user's event, the keyword input on the basis of the search engine.

The system for providing information on the Internet shown in FIG. 4, roughly comprises: a user 420; a search engine 410; a cookie 430; a central server 440; and an advertisement server 450. Data delivering procedure between each constituent are nearly the same as the procedure explained in FIG. 3.

Operation of the system for providing information on the Internet shown in FIG. 4, will be described with the “keyword” input at the search engine by a user, used for the event. The user 420 inputs a keyword at the search engine 410. The input keyword is recorded as history data updated in manner of FIFO, and the history data is collected to and analyzed at the central server 440. The keyword that meets a predetermined reference as a result of analysis of the history data, is extracted as predetermined keyword data, and the extracted keyword data is made in form of an advertisement cookie 430 and stored in the user's terminal. If the user 420 accesses to the Internet, the advertisement cookie 430 stored in the user's terminal is transmitted to the central server 440, and the central server 440 identifies an advertisement identifying symbol included in the advertisement cookie 430 so that an advertisement server 450 may provide a predetermined advertisement to the user 420. Also, as descried above, the advertisement server 450 may also provide a predetermined advertisement to the user 420 by directly receiving the advertisement cookie 430. The predetermined keyword data included in the prepared advertisement cookie is recorded in a predetermined keyword database, as a sale-object keyword that is used in the system for attracting and providing the advertisement using the Internet user's access intention of the present invention, and the keyword database operates in such a way that data recorded on a field for the number of issues of an advertisement cookie or a filed for a user PC number for which the advertisement cookie is issued, is consistently updated according to predetermined keyword data whenever the advertisement cookie in which the predetermined keyword data is included, is issued.

FIG. 5 is a structural block diagram showing another example of the system in which the method for generating the list of the user's access intention keyword data of the present invention shown in FIG. 3, is performed.

Another example of the method for generating the list of the user's access intention keyword data shown in FIG. 5, roughly comprises: a user 520; a search engine 510; a cookie 530; a central server 540; an advertisement server 550; and a client program 560. Data delivering procedure between each constituent are nearly the same as the procedure explained in FIG. 4.

The user 520 inputs a keyword at the search engine 510. The input keyword is collected to and analyzed at the central server 540. The client program 560 which is an element for playing a role that has been performed by the central server 540 in FIG. 4, can be installed in the user's terminal. The input keyword is recorded as history data updated in a manner of FIFO, and the history data is collected to and analyzed at the client program 560. The keyword that meets a predetermined reference as a result of analysis of the history data, is extracted as predetermined keyword data, and the extracted keyword data is made in form of an advertisement cookie 530 and stored in the user's terminal. If the user 520 accesses to the Internet, the client program 560 judges an advertisement object that will be provided by referring to the advertisement cookie 530, and can operate so that the advertisement server 550 may provide a predetermined advertisement to the user 520. Also, as descried above, the advertisement server 550 may also provide a predetermined advertisement to the user 520 by directly receiving the advertisement cookie 530. In the embodiment shown in FIG. 5, the construction for maintaining and updating the keyword database is the same as the construction of the embodiment shown in FIG. 4.

According to still another embodiment of the present invention, it may be also possible that the client program 560 only performs up to the step of generating the advertisement cookie 530, and judging of the advertisement object that will be provided to the user and providing of the advertisement depending on the generated advertisement cookie 530 are performed by the central server 540. It would be understood by a person of an ordinary skill in the art that the above-described functions can be properly distributed between the client program 560 and the central server 540, in other form that is not described in the above embodiment.

The example of the described system for generating the list of the user's access intention keyword data shown in FIGS. 4 and 5, extracts an event judged to be the user's access intention as the keyword data, by analyzing history data for recording a user's keyword log and the keyword, and uses the advertisement file for recording those things. Though, for convenience in explanation, an advertisement cookie file is used as an example of the advertisement file in the present embodiment, it would be obvious to a person of an ordinary skill in the art that any file whatsoever can be used as far as it can record history of a predetermined event or an analyzed event.

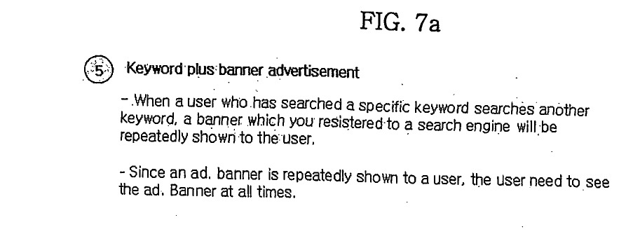

FIG. 6 is a flowchart showing a flow of the method for generating the list of the user's access intention keyword data according to another embodiment of the present invention. Referring to FIG. 6, the method for generating the list of the user's access intention keyword data according to the present invention is performed with use of the described method for judging the Internet user's access intention as follows.

The flow of the method for generating the list of the user's access intention keyword data shown in FIG. 6, is for the case of receiving the URL as an event from the user.

Referring to FIG. 6, a predetermined URL is input from the user (the step of 610). The system of the present invention searches for a predetermined list word that corresponds to the URL by analyzing the input URL, and stores the list word as history data (the step of 615). The method for searching for the corresponding list word by analyzing the URL input at the step of 615, is performed by extracting foremost URL among the input URL and judging in which list word the extracted foremost URL can be expressed. For example, in case the user inputs the URL “www.kipo.go.kr/news/030218”, the system of the present invention extracts “www.kipo.go.kr”, which is the foremost URL among the above URL, and extracts a predetermined list word that corresponds to the extracted foremost URL in reference to the database means for maintaining a predetermined URL information and the corresponding predetermined list word.

Next, the type of the list word stored in the history data is analyzed (the step of 620). At the moment, the type means a predetermined type as to what kind of attribute the event has. Such type can be classified according to a degree of immediacy which the event has, i.e., a period (“effective period” hereinafter) during which the event is understood to be effective in understanding the interested field of the user, which is the same as described in relation to FIG. 3.

Whenever a new URL is input, the history data is updated (the step of 625). Next, on the basis of the type analyzed at the step of 620, whether the list word included in the history data is the user's access intention according to a predetermined reference (the step of 630). The predetermined reference is already described in relation to FIG. 3.

The list word judged to be the user's access intention is extracted as keyword data from the history data (the step of 635). On the basis of the extracted keyword data, the advertisement cookie is made (the step of 640).

The predetermined keyword data included in the made advertisement cookie is a sale-object keyword for use in the method for attracting and providing the advertisement using the Internet user's access intention of the present invention, and is stored in a predetermined keyword database (the step of 645), and in the keyword database, data recorded on a field for the number of issues of an advertisement cookie or a field for a user PC number for which an advertisement cookie is issued, is consistently updated according to predetermined keyword data whenever the advertisement cookie in which the predetermined keyword data is included, is issued (the step of 650).

The method for generating the list of the user's access intention, shown in FIG. 6, according to another embodiment of the present invention, may be performed through a predetermined client program installed in the user's terminal.

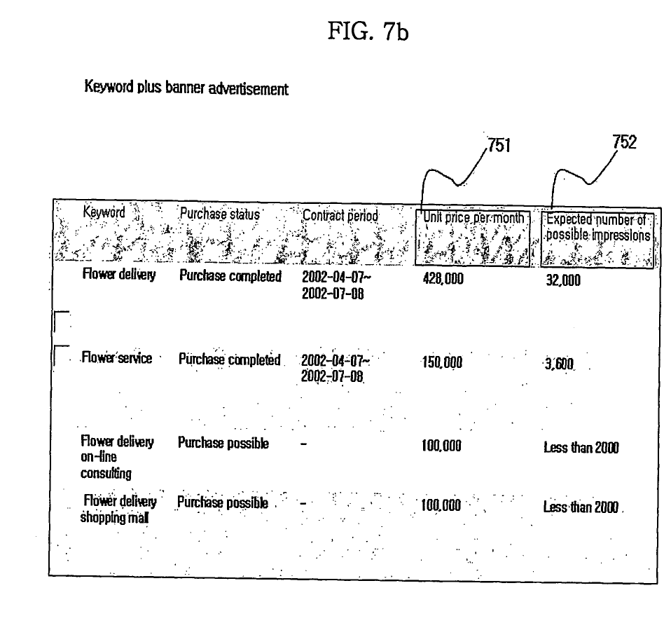

FIG. 7 is a view showing an example of the method for attracting the advertisement on the Internet using the Internet user's access intention.

FIG. 7 shows an example of a screen for attracting the advertisement from a plurality of sponsors with respect to the keyword in order to provide the advertisement of each sponsor for each keyword as the event judged to be input by the user on the basis of understanding of the user's access intention. FIG. 7A shows an example of a guiding message for the advertisement method on the Internet using the user's access intention according to the present invention, which is provided to the sponsor.

FIG. 7B is an example of an advertisement subscription screen provided to the sponsor for advertisement on the Internet using the user's access intention according to the present invention. Referring to FIG. 7B, the advertisement subscription screen may include: a keyword which is the user's access intention and which is desired to be sold; whether the keyword is possibly purchased; a predetermined advertisement contract period; a unit price per month 751; an expected number of possible impressions 752. The expected number of possible impressions 752 can be computed in the following way.

In case the advertisement cookie is issued, information such as an object keyword for which the advertisement cookie is issued, keyword type information, and a predetermined user terminal number for which the advertisement cookie is issued, is stored in a predetermined database means of the system of the present invention. Namely, it is possible to make a database using data regarding the issued advertisement cookie, and to sum up the number of impressions generated at a predetermined Internet website, by each user's terminal, for each keyword included in the issued advertisement cookie. Though such summing up of the number of impressions can be performed for all users of the relevant website as an object, it is also possible to perform summing up of the number of impressions by sampling part of all users and statistically estimate the number of impressions of all users. It is also possible to provide such expected number of possible impressions 752 to the sponsor after statistical data is secured through accumulation of the related data for a predetermined period of time since initial issuance of the advertisement cookie.

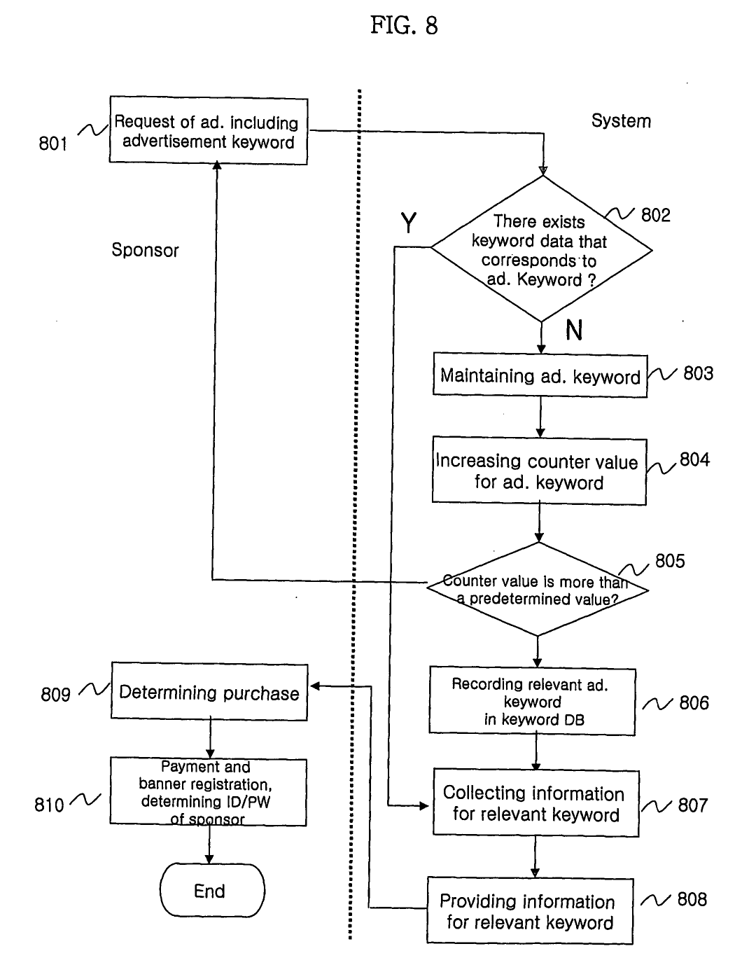

FIG. 8 is a flowchart showing the method for attracting the advertisement on the Internet according to the embodiment of the present invention.

Referring to FIG. 8, the method for attracting the advertisement on the Internet according to the embodiment of the present invention is performed through the following steps. On the first place, an advertisement request that includes a predetermined advertisement keyword is received from a sponsor (the step of 801). For example, it is possible to provide a user interface screen where the advertisement keyword is possibly input, to the sponsor who intends to make a predetermined advertisement with respect to the advertisement keyword “refrigerator”, and to receive the advertisement request through the user interface screen. More specifically, the advertisement keyword included in the received advertisement request is analyzed and whether the keyword data desired to be sold as the advertisement that corresponds to the advertisement keyword exists in a predetermined keyword database, is judged (the step of 802). If there doesn't exist the keyword data that corresponds to the advertisement keyword, the advertisement keyword is stored in a predetermined storing means (the step of 803), and a request counter value with respect to the relevant advertisement keyword is increased (the step of 804). After that, whether the request counter value is more than a predetermined value, is judged (the step of 805), and if the request counter value is less than the predetermined value, the procedure returns back to the step 801 of receiving again the advertisement request. For example, suppose that the advertisement request having the advertisement keyword “refrigerator” is received from the sponsor. If the “refrigerator” does not exist among the keyword data which are advertisement object using the user's access intention of the present invention, the keyword “refrigerator” is stored in a predetermined storing means, and the request counter value is set to 1. If the advertisement request using such keyword “refrigerator” is received more than three times for example, the request counter value for the keyword “refrigerator” becomes 3, and in case the predetermined value is set to 3, the relevant advertisement keyword is stored in the keyword database (the step of 806). Subsequently, information such as the number of issued advertisement cookies including the newly registered keyword data (“refrigerator”) and the number of user terminals for which the relevant advertisement cookie is issued, is collected (the step of 807). The collected information is provided to the sponsor who has made the advertisement request (the step of 808), and the sponsor determines whether to purchase the relevant keyword with reference to the above information (the step of 809). If purchase is determined, a predetermined advertisement banner data that is intended to be provided to the Internet user with respect to the relevant keyword, is transmitted to the system of the present invention, in response to payment, and ID and password information for identifying the sponsor is received from the sponsor (the step of 810).

Also, according to an embodiment of the present invention, the step of attracting the advertisement with respect to a predetermined keyword related to the user's access intention, can be performed in a manner of auction or bidding. Namely, according to the advertisement system of the present invention, advertisement attraction for the keyword data can be performed in the following way, in which: the advertisement system publicly informs a plurality of sponsors the advertisement attraction, by suggesting information such as an estimated number of possible impressions with respect to the relevant keyword data, and a plurality of the sponsors suggests amounts for the advertisement attraction with respect to the keyword, then the advertisement system of the present invention attracts the advertisement of the sponsor who has suggested maximum amount among the advertisements from a plurality of the sponsors.

According to the embodiment of the present invention, the step of providing feedback information for later behavior of the users exposed to the advertisement, to the sponsor, may be additionally provided. For such feedback information, there exists the number of times the user visits the website of the sponsor after being exposed to the relevant advertisement, a visiting period, the number of times of revisit, a ratio of a visit over an advertisement exposure, etc. And, as described above, in case the advertisement system of the present invention maintains in advance basic information such as age, sex, and address of the user, it is possible to provide more detail feedback information to the sponsor on the basis of the above basic information of the user. By providing such feedback information to the sponsor or a person who needs that information, it is possible to quantitatively judge the effect of the information providing according to the present invention.

Also, in the advertisement method using the user's access intention according to the present invention, the payment may be performed in the following way, in which: a predetermined advertisement charge for attracting the advertisement, is suggested to the sponsor together with the information for the relevant keyword at the step of 808 and the suggested amount is paid by the sponsor, or ex-post settling up is performed on the basis of the number of exposures to the relevant keyword data or the number of clicks by the user with respect to the exposures, in view of the feedback information.

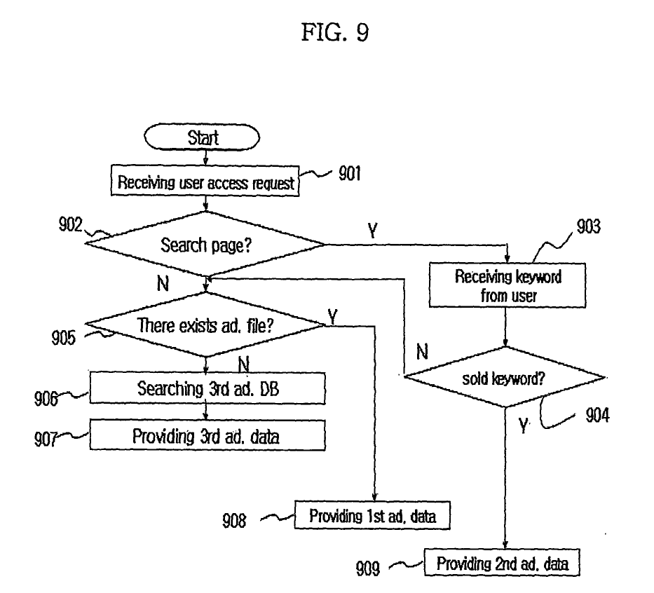

FIG. 9 is a flowchart showing an example of the method for providing the advertisement on the Internet according to the present invention. The example of the method for providing the advertisement on the Internet according to the present invention shown in FIG. 9, is an example about according to which standards a variety of advertisement data including the general keyword advertisement data (the second advertisement data) with respect to the general keyword sale and the general banner advertisement data (the third advertisement data) according to the conventional art besides the keyword advertisement data (the first advertisement data) through judgment of the Internet user's access intention according to the present invention, will be realized on one user interface screen.

According to the embodiment of the present invention, the advertisement data can be provided to the user in the following way.

If an access request to the system of the present invention is received from the user (the step of 901), whether the web page, which is an object of the access request, is a search page, is judged (the step of 902). If the web page is judged to be the search page, a predetermined keyword is input from the user (the step of 903), and whether the input keyword is the keyword sold by a predetermined general keyword sale, is judged (the step of 904). If the input keyword is judged to be the keyword sold by the general keyword sale, it is possible to provide the second advertisement data connected to the relevant keyword, to the user by searching for the general keyword database (the second database) (the step of 909). If the keyword is judged not to be the keyword sold by the general keyword sale at the step of 904, a predetermined cookie folder of the storing means in the user's terminal is searched so that whether a predetermined advertisement file exists, is judged (the step of 905). If the advertisement file is judged to exist, it is possible to provide the first advertisement data that corresponds to a predetermined keyword data included in the advertisement file, to the user (the step of 908). If the advertisement file is judged not to exist at the step of 905, it is possible to provide the third advertisement data to the user by searching for the general banner database (the third database) (the step of 907).

If the page for which the user has made the access request is judged to be the general page (news or game page), not the search page at the step of 902, a predetermined cookie folder of the storing means in the user's terminal is searched and whether a predetermined advertisement file exists, is judged, which is the same as the above-described flow (the step of 905). If the advertisement file is judged to exist, it is possible to provide the first advertisement data that corresponds to predetermined keyword data included in the advertisement file, to the user (the step of 908). If the advertisement file is judged not to exist at the step of 905, it is possible to provide the third advertisement data to the user by searching for the general banner advertisement database (the third database) (the step of 907).

For the method for providing the advertisement according to the present invention shown in FIG. 9, there may exist a variety of modified embodiments. For example, even in case that the keyword is judged to be the keyword sold by the general keyword sale at the step of 904, it is possible to arrange, on one user interface screen, the first advertisement data that corresponds to a predetermined keyword data included in a predetermined advertisement file together with the second advertisement data, by searching for the cookie folder of the storing means in the user's terminal. Also, the flow shown in FIG. 9 is for determining priority between the first through the third advertisement data, and it is possible to arrange the first through the third advertisement data on one user interface screen in various ways and to provide those advertisements to the user.

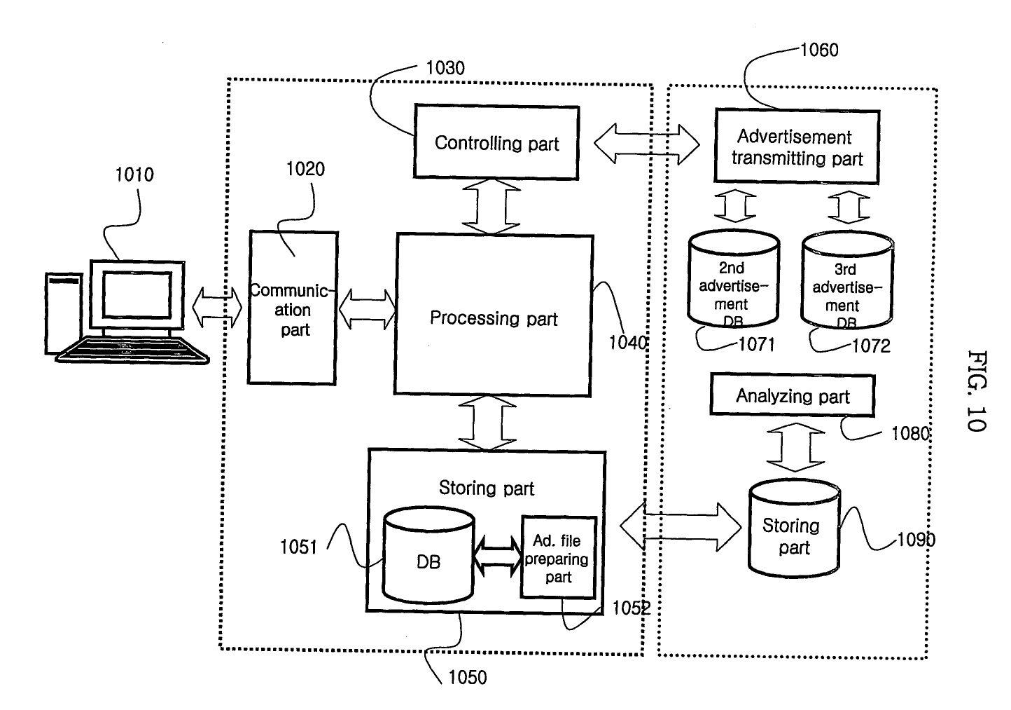

FIG. 10 is a structural block diagram showing an example of the system for attracting and providing the advertisement on the Internet using the Internet user's access intention according to the present invention.

Referring to FIG. 10, the advertisement system on the Internet according to the present invention comprises a central server and an advertisement server. Here, the central server includes: a communication part 1020; a controlling part 1030; a processing part 1040; and a storing part 1050 that comprises a predetermined database 1051 and an advertisement file preparing part 1052. Also, the advertisement server includes: an advertisement transmitting part 1060; a second advertisement database 1071; a third advertisement database 1072; an analyzing part 1080; and a storing part 1090. The block construction of the advertisement system on the Internet according to the embodiment of the present invention will be described in more detail in the following.

The central server plays roles of receiving a predetermined event input by the user, judging the interested field of the user, making the interested field in form of a predetermined advertisement file, and transmitting the advertisement file to a storing means of the system of the present invention and/or the user's terminal 1010. The communication part 1020, which is a detailed module of the central server, receives the event from the user and is responsible for communication between the user's terminal 1010 and the central server.

The processing part 1040 is designed to analyze the type of the received event and judge the interested field of the user according to a predetermined reference on the basis of the analyzed event type. As described above, for an example of event type analysis, the event may be classified according to an effective period. More specifically, the event can be classified as follows, in which: in case of the event such as “flower delivery” which is the keyword that requires strong immediacy, the effective period may be determined to one day, and in case of the event such as “computer” which is the keyword for which intention transition needs to be considered for a predetermined period of time, the effective period may be determined to one week. As described above, the predetermined reference is several conditions selected for each event of the user, which may include more than one among frequency of the event generation, recentness of the event, and priority set in advance in connection with the event. The procedure for analyzing the event type and judging the interested field of the user is the same as the foregoing.

The storing part 1050 is designed to record the interested field of the user and a predetermined symbol capable of identifying the corresponding advertisement. According to the preferred embodiment of the present invention, the advertisement cookie issued to the user is prepared by the advertisement file preparing part 1052 in the inside of the storing part 1050. Since such advertisement cookie is prepared and transmitted to the user, it is possible to record the interested field of the user and the predetermined symbol, and store and manage information such as the interested field for each user and the advertisement related to the interested field, or a symbol for identifying information by providing a predetermined database means 1051 to the storing part 1050. Also, according to the preferred embodiment of the present invention, the database means 1051 that has been provided to the storing part 1050 may be also provided in the inside of the advertisement server, not the central server, so that it possibly performs a predetermined additional function. Also, according to the preferred embodiment of the present invention, in case the user accesses through a predetermined log-in step, it is possible to store the advertisement file in a user information database (not shown), and in case the user logs in and uses a predetermined Internet service afterward, it is also possible to extract the advertisement file by referring to the user information database, and provide a predetermined advertisement related to the advertisement file, to the user.

The controlling part 1030 plays a role of controlling the overall operation of the central server.

The advertisement server, which plays a role of storing and managing a predetermined advertisement content, is responsible for transmitting a predetermined advertisement to the user's terminal 1010 by analyzing the advertisement cookie stored in the user's terminal 1010. Also, according to the embodiment of the present invention, the advertisement server not only possibly makes the advertisement file on which the interested field of the user of the present invention is recorded and provides the advertisement using the above advertisement file, but also possibly provides a variety of advertisements to the user in cooperation with the conventional keyword advertisement or the general banner advertisement system. Referring to FIG. 10, the advertisement server according to the present invention may include: the second advertisement database 1071 for storing advertisement data by which the advertisement is provided to the user through the general keyword sale; and the third advertisement database 1072 for providing advertisement data by which the general banner advertisement is provided to the user. The advertisement transmitting part 1060 provides a variety of advertisement data to the user according to a predetermined reference, under control of the controlling part 1030 of the central server. Namely, on one user interface screen, a variety of advertisement data such as advertisement data according to the interested field of the user, general keyword advertisement data, and general banner advertisement data, is arranged according to a predetermined reference. Such predetermined reference sets priority among those advertisement data. For example, it is possible to arrange, on the upper right side of the user interface, the advertisement of high priority and, on the lower left side of the user interface, the advertisement of low priority. Such priority may be determined depending on advertisement charge paid by the sponsor.

The storing part 1090 plays a role of storing, in case the advertisement cookie is issued, information such as an object keyword for which the advertisement cookie is issued, keyword type information, and a predetermined user terminal number for which the advertisement cookie is issued. Namely, the storing part 1090 makes a database using data for the issued advertisement cookie, and the analyzing part 1080 sums up the number of impressions generated at a predetermined Internet website, by each user terminal, for each keyword included in the issued advertisement cookie. Though such summing up of the number of impressions can be performed for all users of the relevant website as an object, it is also possible to perform summing up of the number of impressions by sampling part of all users and statistically estimate the number of impressions of all users, which is the same as the foregoing. Also, the analyzing part 1080 plays a role of generating predetermined feedback report information which will be provided to the sponsor, by putting together information for the relevant keyword data stored in the storing part 1090.

Also, it is possible that the advertisement server not only provides the advertisement that corresponds to the list of the user's access intention, to the user through the web browser, but also transmits a predetermined advertisement to a user's electronic mail, or even to the user's mobile communication terminal (cellular phone or PDA (Personal Digital Assistant)). Though the advertisement server in FIG. 10 is shown to be arranged, physically separated from the central server, it would be obvious to a person of an ordinary skill in the art that such arrangement is merely exemplary and the discrimination between the central server and the advertisement server is simply a functional discrimination for convenience in explanation.

Also, each of the elements constituting the foregoing advertisement system on the Internet according to the embodiment of the present invention is simply functionally discriminated for convenience in explanation, and has nothing to do with the real physical position or realization of each element.

In addition, embodiments of the present invention further relate to computer readable media that include program instructions for performing various computer-implemented operations. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

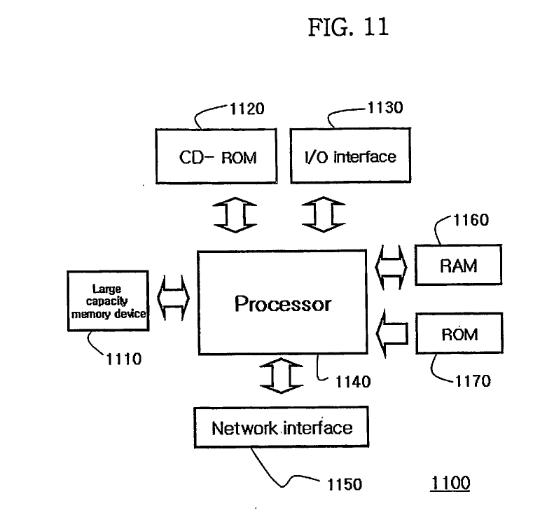

FIG. 11 is an inner block diagram of the general computer system that can be used for the method and system for attracting and providing advertisement on the Internet using the Internet user's access intention of the present invention.

The computer system includes any number of processors 1140 (also referred to as central processing units, or CPUs) that are coupled to storage devices including primary storage 1160 (typically a random access memory, or “RAM”), primary storage 1170 (typically a read only memory, or “ROM”). As is well known in the art, primary storage 1160 acts to transfer data and instructions uni-directionally to the CPU and primary storage 1160 is used typically to transfer data and instructions in a bi-directional manner. Both of these primary storage devices may include any suitable type of the computer-readable media described above. A mass storage device 1110 is also coupled bi-directionally to CPU 1140 and provides additional data storage capacity and may include any of the computer-readable media described above. The mass storage device 1110 may be used to store programs, data and the like and is typically a secondary storage medium such as a hard disk that is slower than primary storage. A specific mass storage device such as a CD-ROM 1120 may also pass data uni-directionally to the CPU. Processor 1140 is also coupled to an interface 1130 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1140 optionally may be coupled to a computer or telecommunications network using a network connection as shown generally at 1150 With such a network connection, it is contemplated that the CPU might receive information from the network, or might output information to the network in the course of performing the above-described method steps. The above-described devices and materials will be familiar to those of skill in the computer hardware and software arts.

While the invention has been shown and described with reference to certain preferred embodiments thereof, it will be understood by those skilled in the art that various changes in form and details may be made therein without departing from the spirit and scope of the invention as defined by the appended claims.

### INDUSTRIAL APPLICABILITY

It is, therefore, an object of a method and system for attracting and providing advertisements on the Internet using an Internet user's access intention according to the present invention, to maximize an advertisement effect, by grasping an Internet user's access intention and by getting a sponsor intending to advertise a predetermined advertisement on the Internet, to possibly provide an advertisement to a user who is interested in a field related to the advertisement of the sponsor.

It is another object of a method and system for attracting and providing advertisements on the Internet using an Internet user's access intention according to the present invention, to resolve the problem of exhaustion of the advertisement resources, by providing a new advertisement scope, growing out of the advertising method based on the general keyword advertisement of the conventional art.

It is still another object of a method and system for attracting and providing advertisements on the Internet using an Internet user's access intention according to the present invention, to create a new advertisement method by grasping an Internet user's access intention in advance and by providing the Internet user's access intention to a sponsor, who wants to provide an advertisement related to such access intention, to a user through the Internet.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method for generating advertisement information to attract advertisement on an Internet, the method comprising the steps of:
maintaining a keyword database for recording more than one keyword, type information of the keyword, predetermined reference information that corresponds to the type information, and advertisement list information that corresponds to the keyword, in which the advertisement list information includes information for the number of advertisement files including the keyword;
receiving a predetermined event from a user;
recording a keyword that corresponds to the received event, for history data;
searching for the type information of the keyword by referring to the keyword database;
searching for the reference information that corresponds to the searched type information;
judging whether the keyword is an interested field of the user on the basis of the searched reference information;
generating an advertisement file including the keyword judged as the interested field of the user;
updating the information for the number of advertisement files in the advertisement list information stored in the keyword database; and
generating advertisement information including the keyword and the updated advertisement list information.

2. The method according to claim 1, wherein the event is one among a keyword input at a search window of an Internet search engine by the user, web page information input at an address window of a web browser by the user, and a hypertext markup language selectively input on the web browser by the user.

3. The method according to claim 1, wherein the type information is predetermined effective period information set in advance for each keyword.

4. The method according to claim 3, wherein the reference information is the number of times the event is input from the user during the effective period.

5. The method according to claim 1, wherein the advertisement file is a cookie file.

6. The method according to claim 5, wherein the advertisement file includes more than one among a terminal number (PC ID) of the user, an identifying symbol of the user, and expiration data information of the advertisement file.

7. The method according to claim 1, wherein the advertisement information additionally includes the number of impressions of a web page that corresponds to the keyword.

8. A method for attracting an advertisement on an Internet, the method comprising the steps of:
maintaining a keyword database for storing more than one keyword and advertisement information generated by the method according to claim 1 in response to the keyword;
receiving an advertisement request that includes an advertisement keyword from a first sponsor;
searching for advertisement information that corresponds to the advertisement keyword by referring to the keyword database;
processing the searched advertisement information and providing guiding information data to a web browser of the first sponsor;
receiving a confirmation response from the first sponsor, in which the confirmation response includes first advertisement data of the first sponsor; and
recording, in a first advertisement database, the advertisement keyword and the first advertisement data that corresponds to the advertisement keyword.

9. The method according to claim 8, wherein the step of searching for advertisement information that corresponds to the advertisement keyword by referring to the keyword database comprises the steps of:
if there is no advertisement information that corresponds to the advertisement keyword, recording, in a predetermined storing means, the received advertisement keyword and an input counter value with respect to the advertisement keyword;
if an advertisement request including the advertisement keyword is received from a second sponsor, increasing the input counter value with respect to the advertisement keyword recorded in the storing means;
judging whether the input counter value is more than a predetermined value; and
if the input counter value is more than a predetermined value, recording, in the keyword database, the advertisement keyword and advertisement information that corresponds to the advertisement keyword.

10. The method according to claim 8, wherein the guiding information data includes more than one among information for the number of the generated advertisement files, information for the number of impressions of a web page that corresponds to the advertisement keyword, and price information of the advertisement keyword.

11. The method according to claim 8, wherein the confirmation response additionally includes payment information for a predetermined advertisement charge.

12. The method according to claim 8, wherein the advertisement request is performed in a manner of auction or bidding.

13. A method for providing a predetermined advertisement to a user of a search engine, the method comprising the steps of:
maintaining an advertisement database for storing more than one keyword and more than one advertisement data that corresponds to the keyword;
receiving an access request from a user, in which the access request includes an advertisement file stored in a user's terminal;
extracting a keyword recorded in the received advertisement file;
searching for the advertisement data that corresponds to the keyword by referring to the advertisement database; and
processing the searched advertisement data and providing the same to a web browser of the user; wherein
the advertisement database is updated through the steps of:
maintaining a keyword database for storing more than one keyword and advertisement information generated by the method according to claim 1 in response to the keyword;
receiving an advertisement request that includes an advertisement keyword from a sponsor;
searching for advertisement information that corresponds to the advertisement keyword by referring to the keyword database;
processing the searched advertisement information and providing guiding information data to a web browser of the sponsor;
receiving a confirmation response from the sponsor, in which the confirmation response includes advertisement data of the sponsor; and
recording, in an advertisement database, the advertisement keyword and the advertisement data that corresponds to the advertisement keyword.

14. A method for providing a predetermined advertisement to a user of a search engine, the method comprising the steps of:
maintaining a first advertisement database for storing more than one keyword and more than one of first advertisement data that corresponds to the keyword;
maintaining a second advertisement database for storing more than one of second advertisement data that corresponds to a predetermined keyword;
receiving an access request from a user, in which the access request includes an advertisement file stored in a user's terminal;
extracting a keyword recorded in the received advertisement file;
searching for the first advertisement data that corresponds to the keyword by referring to the first advertisement database;
receiving a keyword from the user;
searching for the second advertisement data that corresponds to the keyword by referring to the second advertisement database;
constructing a user interface screen by arranging the first advertisement data or the second advertisement data according to a predetermined reference; and
providing the user interface screen to a web browser of the user; wherein
the first advertisement database is updated through the steps of:
maintaining a keyword database for storing more than one keyword and advertisement information generated by the method according to claim 1 in response to the keyword;
receiving an advertisement request that includes an advertisement keyword from a sponsor;
searching for advertisement information that corresponds to the advertisement keyword by referring to the keyword database;
processing the searched advertisement information and providing guiding information data to a web browser of the sponsor;
receiving a confirmation response from the sponsor, in which the confirmation response includes advertisement data of the sponsor; and
recording, in the first advertisement database, the advertisement keyword and the advertisement data that corresponds to the advertisement keyword.

15. The method according to claim 13, further comprising the steps of:
maintaining a second advertisement database for storing more than one of second advertisement data that corresponds to a predetermined keyword; and
maintaining a third advertisement database for storing more than one of third advertisement data; wherein
the step of searching for the advertisement data that corresponds to the keyword by referring to the advertisement database comprises the steps of:
receiving a keyword from the user;
searching for the second advertisement data that corresponds to the keyword by referring to the second advertisement database; and
searching for the third advertisement data by referring to the third advertisement database; wherein
the step of processing the searched advertisement data and providing the same to a web browser of the user comprises the steps of:
constructing a user interface screen by arranging the advertisement data, the second advertisement data, and the third advertisement data according to a predetermined reference; and
providing the user interface screen to a web browser of the user.

16. The method according to claim 14, wherein the second advertisement data is general keyword advertisement data, and the third advertisement data is general banner advertisement data.

17. The method according to claim 13, further comprising the step of providing predetermined feedback information to the sponsor, in which the feedback information includes more than one among the number of times the advertisement is provided to the user, the number of times the user clicks on the advertisement, a time period the user visits the web page of the first sponsor, and the number of times the user visits the web page of the first sponsor after the advertisement is provided.

18. A recording medium readable by a computer, in which a program for performing a method according to claim 1, is recorded.

19. An Internet advertisement system comprising:
a central server comprising:
a keyword database for recording more than one keyword, type information of the keyword, predetermined reference information that corresponds to the type information, advertisement list information that corresponds to the keyword, in which the advertisement list information includes information for the number of the advertisement files that include the keyword;
a communication part for receiving a predetermined event from a user;
a processing part for recording a keyword that corresponds to the received event, for history data, searching for the type information of the keyword and the reference information that corresponds to the searched type information by referring to the keyword database, and judging whether the keyword is the interested field of the user according to the searched reference information;
an advertisement file preparing part for extracting the keyword judged to be the interested field of the user, and generating an advertisement file that includes the extracted keyword, in which the advertisement file includes more than one among a user's terminal number (PC ID), an identifying symbol of the user, and expiration date information of the advertisement file;
an advertisement information generating part for updating information for the number of advertisement files in the advertisement list information stored in the keyword database, and generating advertisement information including the keyword and the updated advertisement list information; and
an advertisement server comprising:
an advertisement database for storing more than one keyword and more than one advertisement data that corresponds to the keyword;
an advertisement transmitting part for processing advertisement data that corresponds to the keyword included in the advertisement file by referring to the advertisement database, and providing the processed advertisement data to a web browser of the user;
a storing part for storing history information about providing of the advertisement data;
an analyzing part for providing predetermined feedback information to a sponsor who has registered the advertisement data, on the basis of the stored history information.

20. The method according to claim 6, wherein the advertisement information additionally includes the number of impressions of a web page that corresponds to the keyword.

21. The method according to claim 15, wherein the second advertisement data is general keyword advertisement data, and the third advertisement data is general banner advertisement data.

22. The method according to claim 14, further comprising the step of providing predetermined feedback information to the sponsor, in which the feedback information includes more than one among the number of times the advertisement is provided to the user, the number of times the user clicks on the advertisement, a time period the user visits the web page of the first sponsor, and the number of times the user visits the web page of the first sponsor after the advertisement is provided.
